(19) United States
(12) Patent Application Publication
(10) Pub. No.: US 2026/0145381 A1
(43) Pub. Date: May 28, 2026

(54) THREE-DIMENSIONAL PRINTING WITH PHOTOBLEACHABLE DYE(S)

(71) Applicant: PERIDOT PRINT LLC, Palo Alto, CA (US)

(72) Inventors: Emre Hiro Discekici, San Diego, CA (US); Jayprakash C. Bhatt, Corvallis, OR (US); Vladek Kasperchik, Corvallis, OR (US)

(21) Appl. No.: 19/095,551

(22) Filed: Mar. 31, 2025

Related U.S. Application Data
(60) Provisional application No. 63/724,819, filed on Nov. 25, 2024.

(51) Int. Cl. B29C 64/165; B29K 77/00; B29K 105/00; B33Y 10/00; B33Y 70/00

(52) U.S. Cl. CPC B29C 64/165; B33Y 10/00; B33Y 70/00; B29K 2077/00; B29K 2105/0032

(57) ABSTRACT

A fusing agent includes from about 20 wt % active to about 60 wt % active of a first solvent, from about 5 wt % active to from about 15 wt % active of a second solvent that is different from the first solvent, from about 0.00445 wt % active to about 5 wt % active of a single photobleachable dye selected from the group consisting of Acid Yellow 73, pyranine, tetrabenzo tetraazoporphyrine, and Acid Blue 9, or a mixture of two photobleachable dyes, and a balance of water. Also disclosed are a three-dimensional printing kit including the fusing agent, and a method of forming the fusing agent.

### CROSS-REFERENCE TO RELATED APPLICATION

This application claims the benefit of U.S. Provisional Application Ser. No. 63/724,819, filed Nov. 25, 2024, the contents of which are incorporated by reference herein in their entirety.

### BACKGROUND

A three-dimensional (3D) printing process is a form of additive manufacturing that can be used to form 3D solid parts, e.g., using a digital model. Some additive 3D printing techniques involve the iterative application of successive layers of materials, such as build material composition(s), fusing agent(s), and the like. In some of these additive 3D printing techniques, at least partial curing, thermal merging/fusing, melting, sintering, etc. of the build material composition(s) may be used to form 3D solid parts, and the mechanism for material coalescence may depend upon the type of build material composition(s) used. For some materials, at least partial melting may be accomplished using heat-assisted extrusion, and for some other materials, curing or fusing may be accomplished using photonic energy sources, such as ultra-violet light or infrared light. 3D printing techniques may be used to generate 3D printed parts with various properties, such as parts having mechanical strength suitable for a particular application.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features of examples of the present disclosure will become apparent by reference to the following detailed description and drawings.

FIG. 1 is an ultraviolet (UV) spectrum overlay of Acid Yellow 73, Acid Blue 9, and Acid Red 52 dyes, showing the absorbance (Arbitrary Units, Y axis) of each of these dyes at wavelengths ranging from 350 nm to 750 nm (X axis).

FIG. 2 is a bar graph illustrating the percentage of missing nozzles of a printhead of a 2D inkjet printer after several printing passes of four sample fusing agents of the present disclosure.

FIG. 3 is a line graph illustrating the short term decap performance of four sample fusing agents of the present disclosure.

FIG. 4A is a photograph of a two-dimensional (2D) test print of a sample fusing agent including Acid Yellow 23 (AY-23) dye as an energy absorber applied to plain paper prior to photobleaching. In the photograph shown in FIG. 4A, the 2D print included a print region having a medium yellow color.

FIG. 4B is a photograph of the 2D test print of the fusing agent of FIG. 4A after exposure to sunlight for 24 hours. In the photograph shown in FIG. 4B, the print region of the 2D test print faded to a light-yellow color.

FIG. 5A is a photograph of a two-dimensional (2D) test print of a sample fusing agent including Acid Yellow 73 (AY-73) dye as an energy absorber applied to plain paper prior to photobleaching. In the photograph shown in FIG. 5A, the 2D print included a print region having a medium yellow color.

FIG. 5B is a photograph of the 2D test print of the fusing agent of FIG. 5A after exposure to sunlight for 24 hours. In the photograph shown in FIG. 5B, the print region of the 2D test print faded such that the print region had the same color as the underlying paper.

FIG. 6A is a photograph of a melt-fused coupon using a sample fusing agent including AY-73 dye as an energy absorber applied on polyamide-12 powder prior to photobleaching. In the photograph shown in FIG. 6A, the coupon exhibited a light-yellow color.

FIG. 6B is a photograph of the coupon of FIG. 6A after exposure to sunlight for 24 hours. In the photograph shown in FIG. 6B, the coupon faded to a slightly lighter yellow color.

FIG. 7A is a photograph of another melt-fused coupon using a sample fusing agent including AY-73 dye as an energy absorber applied on polyamide-12 powder prior to photobleaching. In the photograph shown in FIG. 7A, the coupon exhibited a light-yellow color.

FIG. 7B is a photograph of the coupon of FIG. 7A after exposure to sunlight for 24 hours. In the photograph shown in FIG. 7B, the coupon faded to a slightly lighter yellow color.

FIG. 8A is a photograph of a spherical object that was 3D printed using a sample fusing agent including a combination of Acid Yellow 23 and Acid Red 52 dyes as an energy absorber. In the photograph shown in FIG. 8A was taken prior to photobleaching and the object exhibited an orange color.

FIG. 8B is a photograph of the spherical object of FIG. 8A after exposure to natural sunlight for 3 to 4 weeks. In the photograph shown in FIG. 8B, the object had faded to a yellow color.

### DETAILED DESCRIPTION

Some 3D printing methods or techniques utilize an energy absorbing substance (e.g., an energy absorber) to pattern a build material composition, thereby forming a patterned region of the build material composition. In these methods or techniques, an entire layer of the build material composition is exposed to radiation, and the patterned region of the build material composition is coalesced and becomes a layer of a 3D solid part (or 3D printed object). As used herein, the term “coalescence” refers to a process where individual droplets and/or particles of material merge together to form a continuous, solid structure. In this context, coalesced material has merged to form a continuous, solid structure. In the patterned region of build material composition, the energy absorbing substance is capable of at least partially penetrating into voids between the particles of the build material composition and is also capable of spreading onto an exterior surface of particles within the build material composition. The energy absorbing substance is also capable of converting absorbed radiation energy into thermal energy, which may be used to coalesce build material particles that have been patterned with the energy absorbing substance. Coalescing causes the build material particles to join or blend to form a single entity (i.e., a layer of the 3D solid part). Coalescing may involve at least partial thermal merging, melting, binding, and/or some other mechanism that causes the build material composition to form the layer of the 3D solid part.

Some 3D printing methods or techniques, such as Multi Jet Fusion (MJF) technology, equipped with infrared (IR) or ultraviolet (UV) electromagnetic energy source(s), utilize a fusing agent that includes, respectively, an IR or UV energy absorber to achieve build material coalescence. Such methods or techniques may result in strongly colored 3D solid parts or layer(s) of the 3D solid part, depending, at least in part, on the type and concentration or amount of energy absorber used, and possibly other components used in the 3D printing method or technique. For example, some 3D printing methods utilize high concentrations of darkly-colored IR energy absorbers (e.g., carbon black absorbers), and the darkly-colored energy absorbers produce darkly-colored objects (e.g., black, dark grey, or other similar dark color). The dark color may be unsuitable for some 3D solid parts, for example, where a predetermined color for the final part is white, off-white, or a light-color. Additionally, it can be a challenge to color over (such as by a post-process dyeing technique) 3D solid parts having a dark base color to produce final parts exhibiting a white, off-white, or light color.

While alternatives to darkly-colored IR energy absorbers have been explored, such alternative IR energy absorbers (low-tint energy absorbers such as plasmonic resonance absorbers, e.g., cesium tungsten oxide) tend to lack the same performance capabilities of the darkly-colored energy absorbers. For instance, difficulties can be encountered when endeavoring to incorporate a low-tint energy absorber into the fusing agent while maintaining the jettabillity of the fusing agent (e.g., via thermal inkjet applicators) and the ability of the fusing agent to absorb enough radiation to suitably heat and coalesce the build material particles. Plasmonic resonance absorbers can also interfere with the color fidelity of the 3D solid parts. Such NIR absorbers work by manipulating light at specific wavelengths, which can alter the perceived color of the build material. This makes it challenging to achieve accurate and consistent colors in the 3D solid parts. Further, plasmonic resonance absorbers can generate significant heat when exposed to light, which can adversely affect the printing process and can lead to warping or other defects in the 3D solid objects, especially when printing with thermally sensitive materials.

Some have proposed the use of MJF 3D printers with UV fusing lamps (365 nm) and a fusing agent having a colorless UV absorber to print 3D solid parts that do not have a darkly-colored color. However, UV absorbers can present formulation challenges due, at least in part, to their limited solubility in aqueous vehicles.

In some instances, whiteners may be incorporated into the build material to produce 3D solid parts having a white or off-white base color. However, some whiteners, such as TiO₂ particles, have a high Mohs hardness and, thus, the whitener can be quite abrasive, which can wear down printer components (e.g., print nozzles). TiO₂ particles also tend to agglomerate, which can lead to clumping and cause inconsistencies in the printed build material. This, in turn, can adversely affect the quality and surface finish of the 3D solid part. While coated TiO₂ particles may reduce agglomeration, the coating can add some complexity to preparing the build material for use in 3D printing. Further, TiO₂ particles often require higher printing temperatures, which can complicate the 3D printing process.

The present disclosure provides a fusing agent and a 3D printing kit including the fusing agent which can be used to make 3D printed parts exhibiting a base color that can be altered (e.g., bleached) to achieve a final color, such as white, off-white, or a lighter color than the base color. The base color is altered by post-process exposure of the 3D printed parts to a predetermined wavelength of light for a predetermined period of time. As mentioned, after post-process exposure to the light, the final part exhibits a final color that is white, off-white, or a light color. The fusing agent escribed herein avoids the use of tungsten bronzes or other similar low-tint radiation absorbers during 3D printing, and the kit avoids the use of whiteners (such as TiO₂) in the build material. The 3D printed parts can be formed using current printing technology employing visible light energy source(s) and a fusing agent containing a relatively low concentration of selected photobleachable dye(s) as the energy absorber. Some of the photobleachable dye(s) selected for the fusing agent exhibit(s) fluorescent properties, which are prone to both alpha and beta radiative decay pathways. With these dye(s), energy that is absorbed is emitted as light rather than converted to heat. This is different from non-fluorescent dyes, which primarily observe non-radiative decay upon absorption of electromagnetic energy. The ability to achieve strong 3D printed parts with these fluorescing photobleachable dye(s) was unexpected, due to the fact that less of the absorbed energy is converted to heat. As demonstrated in the Examples below, it was found that with the selected photobleachable dye(s), which exhibit fluorescent properties, photo-altering of the color and/or photobleaching of the parts can be readily achieved.

The fusing agent of the present disclosure includes a combination of solvents and either i) a single photobleachable dye selected from the group consisting of Acid Yellow 73, pyranine, tetrabenzo tetraazoporphyrine, and Acid Blue 9 or ii) a mixture of two photobleachable dyes. The combination of two photobleachable dyes can include a first photobleachable dye and a second photobleachable dye that is more fluorescent than the first phobobleachable dye. The 3D printed objects can be subjected to post-process bleaching, such as exposing the 3D printed objects to UV light (e.g., sunlight) for a predetermined period of time to yield white, off-white, or lightly-colored final parts. Such white, off-white, or lightly-colored final parts would have a relatively high L* value, e.g., an L* of greater than 80. L* is the lightness value with black at zero (0) and white at one hundred (100). A greater L* value indicates that the final part has a lighter color. L* is measured in the CIELAB color space, and may be measured using any suitable color measurement instrument (such as those available from HunterLab or X-Rite). The L* values may be accompanied a* and b* values, where the a* axis is relative to the green-red opponent colors, with negative values toward green and positive values toward red and the b* axis represents the blue-yellow opponents, with negative numbers toward blue and positive toward yellow.

Further, the presence of the solvents in the fusing agent of the present disclosure helps to modify the thermal properties of the build material such that onset of the melt temperature of the build material is reduced. In particular, the use of plasticizing solvents facilitates a melt temperature reduction of the polymer. This, in turn, facilitates improved fusing between build material layers. As such, use of the fusing agent during printing can thereby improve mechanical properties of the 3D printed part, in addition to enabling a wide variety of colors to be added to the 3D printed part during its fabrication.

In an example, the fusing agent, as disclosed herein, includes a solvent, a photobleachable dye, and water. For instance, the fusing agent includes from about 20 wt % active to about 60 wt % active of a first solvent, from about 5 wt % active to about 15 wt % active of a second solvent that is different from the first solvent, from about 0.00445 wt % active to about 5 wt % active of either i) a single photobleachable dye selected from the group consisting of Acid Yellow 73, pyranine, tetrabenzo tetraazoporphyrine, and Acid Blue 9 or ii) a mixture of two photobleachable dyes, and a balance of water.

Also disclosed herein is a method of using the fusing agent, which comprises forming a layer of a polymeric build material composition, based on a 3D object model, selectively applying the fusing agent to the polymeric build material composition, and exposing the layer to light that the single photobleachable dye or the mixture of two photobleachable dyes is capable of absorbing.

An example of the 3D printing kit includes a fusing agent and a polymeric build material composition. The fusing agent includes from about 20 wt % active to about 60 wt % active of a first solvent, from about 5 wt % active to about 15 wt % active of a second solvent that is different from the first solvent, from about 0.00445 wt % active to about 5 wt % active of either i) a single photobleachable dye selected from the group consisting of Acid Yellow 73, pyranine, tetrabenzo tetraazoporphyrine, and Acid Blue 9 or ii) a mixture of two photobleachable dyes, and a balance of water.

Also disclosed herein is a method for making a fusing agent for 3D printing. The method comprises selecting a single photobleachable dye or a mixture of two photobleachable dyes to achieve a predetermined color upon photobleaching, and mixing the single photobleachable dye or the mixture of two photobleachable dyes in a liquid vehicle including at least 50% solvent, thereby forming a fusing agent for 3D printing.

Throughout this disclosure, a weight percentage that is referred to as “wt % active” refers to the weight percentage of the active component in a solution, mixture, or other formulation. This is calculated by taking the mass of the active component and dividing it by the total mass of the solution/mixture/formulation, then multiplying by 100 to get a percentage. Essentially, it represents the concentration of the active ingredient in a formulation, excluding any other non-active components present in the formulation. As an illustration, an energy absorber, such as a photobleachable dye, may be present in a water-based formulation (e.g., a stock solution or dispersion) before being incorporated into a 3D printing fusing agent. In this example, the wt % active of the energy absorber accounts for the loading (as a weight percent) of the energy absorber that is present in the 3D fusing agent, and does not account for the weight of the other components (e.g., water, etc.) of the stock solution or dispersion.

Additionally, throughout this disclosure, the terms “3D printing fusing agent,” “3D fusing agent,” and “fusing agent” are used interchangeably herein, and the terms “3D solid part”, “3D printed part”, “3D printed object”, “3D part”, and “3D object” are used interchangeably herein.

### 3D Printing Kit

In an example, the 3D printing kit includes the fusing agent and the polymeric build material composition. In another example, the 3D printing kit further includes a detailing agent. Details of the fusing agent, the detailing agent, and the polymeric build material composition are set forth below.

It should be understood that the fusing agent and the polymeric build material composition (and the detailing agent, when included) of the 3D printing kit may be maintained or contained separately until used together in a method for using the fusing agent described in detail below. The fusing agent and/or the polymeric build material composition (and/or the detailing agent) may each be contained in a container prior to and during the method, but may be combined together during the method. The containers can be any type of vessel (e.g., reservoir, box, or receptacle) made of any material.

### Fusing Agent

In an example, the fusing agent of the present disclosure includes a solvent, a photobleachable dye, and water. In a particular example, the fusing agent includes first and second solvents, either i) a single photobleachable dye selected from the group consisting of Acid Yellow 73, pyranine, tetrabenzo tetraazoporphyrine, and Acid Blue 9 or ii) a mixture of two photobleachable dyes, and water. In some examples, the fusing agent includes the solvent(s), the photobleachable dye(s), and water, as well as an additive. In other examples, the fusing agent consists of the solvent(s), the photobleachable dye(s), and water. In still other examples, the fusing agent consists of the solvents, the photobleachable dye(s), water, and a surfactant as an additive.

The fusing agent may be made by combining the solvent(s), the photobleachable dye(s), and the water together. The solvent(s) and the water (and, in some instances, additive(s) described below) make up a liquid vehicle of the fusing agent. The photobleachable dye(s) may be in the form of a powder or a liquid. If in the form of a powder, the photobleachable dye(s) may be incorporated directly into the liquid vehicle, and then all of the components are mixed together to form a fusing agent solution. A liquid dye may be 100% liquid dye or a dye solution, the latter of which includes the photobleachable dye dissolved in a solvent. When a dye solution is incorporated into the liquid vehicle, the solvent of the dye solution becomes part of the fusing agent. As an example, the solvent in the dye solution is water. As another example, the solvent in the dye solution is an organic solvent.

The photobleachable dye that is incorporated into the fusing agent can be either i) a single (i.e., one) photobleachable dye or ii) a mixture of two photobleachable dyes. The photobleachable dye(s) present in the fusing agent is capable of absorbing electromagnetic energy at certain wavelengths, and so the photobleachable dye(s) functions as an energy absorber in the fusing agent. Some suitable photobleachable dyes exhibit fluorescent properties, and these may be referred to herein as a fluorescent dye or a fluorophore. “Fluorescence” is a physical property of a material that absorbs radiation (e.g., light) at one wavelength and remits radiation (e.g., light) at another wavelength. Each of the photobleachable dyes that may be selected for use in the fusing agent of the present disclosure is capable of absorbing radiation within the spectrum of visible light. In an example, each of the photobleachable dyes that may be selected for use in the fusing agent has substantial absorption at wavelengths ranging from about from about 380 nm to about 700 nm. In another example, each of the photobleachable dyes selected for use in the fusing agent has substantial absorption at wavelengths ranging from about 400 nm to about 590 nm. As used herein, the term “substantial absorption” means that at least 80% of radiation having wavelengths within the specified range is absorbed by the substance being referred to (e.g., the photobleachable dye(s)). Even with its fluorescing property and at the low loadings/concentrations set forth herein, each of the photobleachable dyes is capable of absorbing and converting absorbed radiation into a sufficient amount of thermal energy to fuse/coalesce build material particles that have been patterned with the fusing agent (as will be described in more detail with reference to a 3D printing method below). In this regard, the photobleachable dye(s), at the low loading/concentration, is/are a suitable energy absorber for the fusing agent.

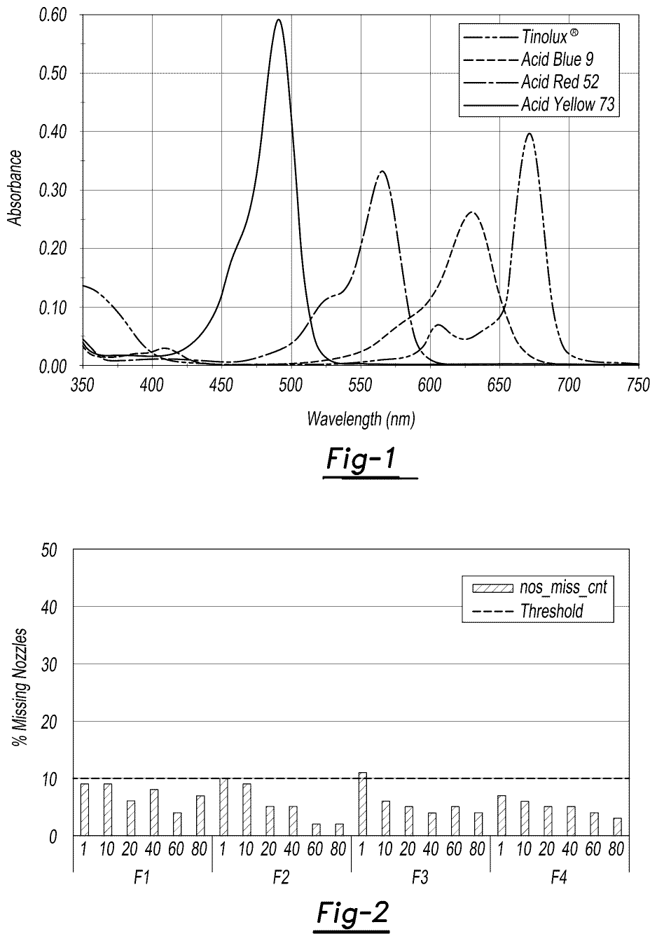

Each of the photobleachable dyes that may be selected for the fusing agent of the present disclosure is an organic or inorganic dye having an original color and is capable of being photochemically altered, during post-processing, such that the altered dye exhibits a white, off-white, or a lightened color (relative to the base color). Examples of photobleachable dyes that may be used for the fusing agent include Acid Yellow 23, Acid Yellow 73, Acid Red 52, Acid Blue 9, pyranine, tetrabenzo tetraazoporphyrine, and combinations thereof. FIG. 1 is a UV spectrum overlay of Acid Blue 9, Acid Red 52, Acid Yellow 73, and tetrabenzo tetraazoporphyrine (TINOLUX® from BASF Corp.). FIG. 1 shows that the absorbance peak of each of these dyes falls within the visible light range, indicating that each of these dyes are feasible choices for use in 3D printers employing visible light fusing lamps (e.g., visible light emitting diodes (LED).

In one example, the fusing agent includes a single photobleachable dye selected from any of the dyes listed above. In a particular example, the fusing agent includes a single photobleachable dye selected from the group consisting of Acid Yellow 73, pyranine, tetrabenzo tetraazoporphyrine, and Acid Blue 9. When a single dye is used, the dye will fade or bleach during photobleaching to produce a white, off-white, or lighter color compared to the base color of the object.

In an alternative example, the fusing agent includes a mixture or combination of two photobleachable dyes. In one alternative example, the two photobleachable dyes include a first photobleachable dye selected from the group consisting of Acid Yellow 23, Acid Yellow 73, and pyranine, and a second photobleachable dye selected from the group consisting of Acid Red 52 and Acid Blue 9. In this example, the second dye of the mixture/combination is more fluorescent compared to the first dye. In this particular example, the first dye of the mixture/combination is more stable than the second dye in that it is not as photobleachable and in terms of its ability to convert the absorbed energy to heat rather than fluorescence. Both dyes are photobleached, but the second dye bleaches more than the first dye. As illustrated the Examples section, during photobleaching, the second dye fades or bleaches more and thus the color of the first dye remains in the final part. For instance, when Acid Yellow 23 is used as the first dye and the Acid Red 52 is used as the second dye, the 3D printed part that is formed has an orange base color. The Acid Red 52 dye (i.e., second dye) fades more than the Acid Yellow 23 dye (i.e., first dye), and thus some of the yellow dye remains upon photobleaching, leaving a yellow-colored final part. In other examples, one or both of the photobleachable dyes in the combination are non-fluorescing photobleachable dyes.

In other examples, the fusing agent includes a mixture or combination of three or four photobleachable dyes.

While a few examples of the photobleachable dye have been listed, it should be understood that there may be other photobleachable dyes not mentioned above that both i) exhibit a radiation absorbing property and ii) are capable of being photochemically altered and, thus, can be suitable for use in the fusing agent of the present disclosure.

The photobleachable dye(s) is/are present in the fusing agent in a low amount. Because the photobleachable dye(s) are ultimately beached away, a lower amount equates to less dye that has to be removed. The ability to use a lower amount is due, at least in part, to the presence of the solvent used in the fusing agent. The presence of the solvent can plasticize the polymeric powder and lower its melting point, which facilitates efficient fusing at a lower dye loading. Additionally, having more solvent cools the patterned build material less than water, so efficient fusing can take place even at the low dye loading.

As used herein, a “low amount” or “low loading” or “low concentration” of the photobleachable dye(s) means that 5 wt % active or less of the photobleachable dye(s) is present in the fusing agent, based on a total weight of the fusing agent. In an example, the fusing agent includes from about 0.00445 wt % active to about 5 wt % active of the single photobleachable dye or the mixture of the two photobleachable dyes. In another example, the fusing agent includes from about 0.00445 wt % active to about 0.89 wt % active or from about 0.1 wt % active to about 0.6 wt % active of the single photobleachable dye or the mixture of two photobleachable dyes. In still another example, the fusing agent includes from about 0.00445 wt % active to about 0.445 wt % active of the single photobleachable dye or the mixture of the two photobleachable dyes. In a particular example, the fusing agent includes the mixture of two photobleachable dyes, which includes from about 0.00445 wt % active to about 0.445 wt % active of the first photobleachable dye and from about 0.00445 wt % active to about 0.445 wt % active of the second photobleachable dye that is more fluorescent than the first photobleachable dye. All of the foregoing ranges are based on a total weight of the fusing agent.

The fusing agent further includes the solvent. In an example, the fusing agent includes first and second solvents. The first and second solvents may be incorporated into the fusing agent separately or may be combined into a solvent package. As used herein, a “solvent package” refers to the combination of the first and second solvents, other than water, present in the fusing agent. It is possible that the fusing agent could include additional solvent(s) or co-solvent(s) other than water, and these additional solvents would become part of the solvent package. Further, each of the solvents used in the fusing agent can be plasticizing solvents. The term “plasticizing solvent” refers to a non-volatile or low-volatile solvent that interacts with and increases the flexibility of (i.e., plasticizes) the build material polymer. This may generate a more pliable surface that improves dye penetration. It is to be understood that throughout this disclosure, the terms “solvent” and “co-solvent” are used interchangeably.

The first and second solvents may be combined together to form the solvent package. The solvent package may be formed prior to being combined or mixed with other component(s) of the fusing agent (e.g., the photobleachable dye(s) and other component(s) of the liquid vehicle). Alternatively, each of the first and second solvents could be incorporated into the fusing agent separately.

Examples of solvents that can be used for the first and second solvents include 1-(2-hydroxyethyl)-2-pyrrolidone, 2-pyrrolidone, 2-phenoxyethanol, isopropylidene glycerol, glycerol, 2-methyl-1,3-propanediol, 1,2-butane diol, diethylene glycol, triethylene glycol, tetraethylene glycol, polyethylene glycol, isopropyl alcohol, propylene glycol, dipropylene glycol, diethylene glycol butyl ether, lactone derivatives, an aromatic alcohol, and combinations thereof. All of the foregoing solvents are considered to be plasticizing solvents. If an aromatic alcohol is used for one of the solvents, the aromatic alcohol can be benzyl alcohol having the formula C₆H₅CH₂OH. Another aromatic alcohol that could be used is 2-phenoxyethanol. In one example of the fusing agent, the first solvent is 1-(2-hydroxyethyl-2-pyrrolidone); and the second solvent is selected from the group consisting of benzyl alcohol and propylene glycol.

In an example, the first solvent of the fusing agent is 1-(2-hydroxyethyl)-2-pyrrolidone (also known as N-(2-hydroxyethyl)-2-pyrrolidone or HE2P). The first solvent may be present in the fusing agent in an amount ranging from about 20 wt % active to about 60 wt % active, based on the total weight of the fusing agent. In another example, the first solvent is present in an amount ranging from about 30 wt % active to about 50 wt % active, based on the total weight of the fusing agent.

The second solvent of the fusing agent is different from the first solvent. In an example, the second solvent is selected from the group consisting of benzyl alcohol and propylene glycol (also known as PG or 1,2-propanediol). The second solvent may be present in the fusing agent ranging from about 5 wt % active to about 15 wt % active, based on the total weight of the fusing agent. In another example, the second fusing agent is present in an amount ranging from about 8 wt % active to about 12 wt % active, based on the total weight of the fusing agent.

In instances where benzyl alcohol is used as the second solvent, the 1-(2-hydroxyethyl)-2-pyrrolidone suitably increases the water solubility of the benzyl alcohol. In other words, the 1-(2-hydroxyethyl)-2-pyrrolidone assists in bringing the benzyl alcohol into solution. The inclusion of such a solvent enables the fusing agent to be prepared with a predetermined amount of the benzyl alcohol that is suitable for solubilizing and plasticizing the build material during 3D printing.

In another example, the solvent package may include a combination of N-(2-hydroxyethyl)-2-pyrrolidone and propylene glycol.

The fusing agent may also include additive(s), such as a surfactant, an antimicrobial agent, a chelating agent, an anti-kogation agent, a buffer, and a combination thereof. In a particular example, the fusing agent includes a surfactant as an additive. The total amount of each additive(s) present in the fusing agent ranges from about 0.01 wt % active to about 5 wt % active, based on the total weight of the fusing agent. In another example, the total amount of each additive(s) present in the fusing agent ranges from about 0.01 wt % active to about 2 wt % active, based on the total weight of the fusing agent. It is to be understood that in any of these examples, “the additive” refers to any of the aforementioned additives, including the combination of listed additives.

The fusing agent may include a surfactant as the additive. Examples of surfactants that may be used for the fusing agent include non-ionic or anionic surfactants. Some example surfactants include alkyl polyethylene oxides, alkyl phenyl polyethylene oxides, polyethylene oxide block copolymers, acetylenic polyethylene oxides, polyethylene oxide (di)esters, polyethylene oxide amines, dimethicone copolyols, substituted amine oxides, fluorosurfactants, and the like. Some examples of these surfactants include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another anionic surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used, or a combination of surfactants is used, the total amount of surfactant(s) ranges from about 0.01 wt % active to about 2 wt % active, based on the total weight of the fusing agent. In another example, the total amount of surfactant(s) ranges from about 0.5 wt % active to about 1.5 wt % active, based on the total weight of the fusing agent. In a particular example, the total amount of surfactant(s) used is about 0.75 wt % active, based on the total weight of the fusing agent.

Anti-microbial agents are also known as biocides and/or fungicides. Examples of suitable anti-microbial agents that may be used as an additive in the fusing agent include NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant Int. Ltd.), blends of 5-chloro-2-methyl-4-isothiazolin-3-one (CIT or CMIT) and MIT under the tradename KATHON™ (The Dow Chemical Company), and combinations thereof.

In an example, the total amount of antimicrobial agent(s) ranges from about 0.01 wt % active to about 0.05 wt % active, based on the total weight of the fusing agent.

Chelating agents (or sequestering agents) may be included in the fusing agent to eliminate the deleterious effects of heavy metal impurities. In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

Whether a single chelating agent is used or a combination of chelating agents is used, the total amount of chelating agent(s) may range from greater than 0 wt % active to about 0.5 wt % active, based on the total weight of the fusing agent.

In some examples, the additive in the fusing agent is an anti-kogation agent. “Kogation” refers to the deposit of dried printing liquid (e.g., the fusing agent) on a heating element of a thermal inkjet printhead. Anti-kogation agent(s) is/are included to assist in preventing the buildup of kogation. Examples of anti-kogation agents include oleth-3-phosphate (commercially available as CRODAFOS™ O3A or CRODAFOS™ N-3A) or dextran 500,000. Other examples of the anti-kogation agents include CRODAFOS™ HCE (a phosphate-ester from Croda Int.), CRODAFOS® O10A (oleth-10-phosphate from Croda Int.), and DISPERSOGEN® LFH (a polymeric dispersing agent with aromatic anchoring groups, acid form, anionic, from Clariant Int. Ltd.), etc. It is to be understood that any combination of the anti-kogation agents listed may be used.

In an example, the total amount of anti-kogation agent(s) may range from greater than 0 wt % active to about 0.5 wt % active, based on the total weight of the fusing agent.

The liquid vehicle may further include a buffer as an additive. Examples of suitable buffers include tris(Hydroxymethyl)aminomethane based buffers, such as TRIS and TRIZMA, and (4-(2-hydroxyethyl)-1-piperazineethanesulfonic acid) (HEPES).

In an example, the total amount of buffer(s) may range from 0.01 wt % active to about 1 wt % active, based on the total weight of the fusing agent.

The liquid vehicle of the fusing agent further includes water. The water generally makes up a balance of the fusing agent, relative to the other components included in the fusing agent (e.g., the photobleachable dye(s) and other liquid vehicle components). The amount of water included in the fusing agent depends upon the amount of each of the other components included in the fusing agent. In an example, the amount of water present in the fusing agent ranges from 10 wt % to about 80 wt %, based on the total weight of the fusing agent. In another example, the amount of water present in the fusing agent ranges from 25 wt % to 75 wt %, based on the total weight of the fusing agent. The water may be pure water, deionized water (DI water), distilled water, or any other suitable form of water.

Table 1 below illustrates an example formulation of the fusing agent that may be used:

TABLE 1

| Component | % active | wt % |
|---|---|---|
| First Solvent | 100 | 20-60 |
| First Photobleachable Dye | 8.9 | 0.05-5 |
| Second Photobleachable Dye | 8 | 0.05-5 |
| Second Solvent | 100 | 5-15 |
| Surfactant | 100 | 0.75 |
| Water | 100 | Balance |

The fusing agent may be formed by selecting either i) a single photobleachable dye or ii) a mixture of two photobleachable dyes to achieve a predetermined color upon photobleaching. In an example, Acid Yellow 73 may be selected as the single photobleachable dye, and the 3D part formed using the fusing agent fades or bleaches to an off-white color during post-process photobleaching. In another example, Acid Yellow 23 may be selected for the single photobleachable dye, and the 3D part formed using the fusing agent fades or bleaches to a light-yellow color during post-processing photobleaching. In yet another example, a mixture of Acid Yellow 23 and Acid Red 52 may be selected as the mixture of photobleachable dyes, and the 3D part formed using the fusing agent fades or bleaches to a yellowish color during post-process photobleaching. Because the Acid Red 52 is more fluorescent than the Acid Yellow 23, and the Acid Yellow 23 is more stable than the Acid Red 52, the Acid Red 52 dye is photobleached at a faster rate and at least some of the Acid Yellow 23 dye remains, thereby producing a yellow color during post-process bleaching. This example illustrates that the combination of dyes may be selected so that photobleaching yields the predetermined color. In particular, the first dye, which is less photobleachable than the second dye, may be selected to impart the predetermined color or to mix with the photobleached color to achieve the predetermined color. The rate of photobleaching may vary with different types of powder (e.g., PA12, TPA, etc.), as well as pH and other properties of the fusing agent. The photobleachable dyes in the combination may be selected with different rates of bleaching to achieve the predetermined color of final 3D part.

The method of forming the fusing agent further includes mixing the single photobleachable dye or the mixture of the two photobleachable dyes in the liquid vehicle, which includes at least 25% solvent. The at least 25% solvent accounts for the presence of the first and second solvents, but not the water. In an example, the liquid vehicle includes at least 25% solvent and water, and, in some examples, at least one additive. Mixing involves stirring, shaking, or otherwise mixing the photobleachable dye(s) in the liquid vehicle including the solvents, the water, and, in some examples, the at least one additive. In an example, the liquid vehicle includes from about 20 wt % active to about 60 wt % active of the first solvent, from about 5 wt % active to about 15 wt % active of the second solvent that is different from the first solvent, a surfactant, and water.

Any example of the fusing agent set forth herein can be used in a 3D printing method, which is applied to a build material composition. The fusing agent may be used in the 3D printing method with or without a detailing agent. The detailing agent and the build material composition are described further below.

### Second Fusing Agent

In some examples, two fusing agents may be used together to achieve the predetermined final color of the 3D printed object. In this example, the first of the two fusing agents includes the single photobleachable dye, where the single photobleachable dye is Acid Yellow 73 or pyranine. The second of the two fusing agents includes from about 20 wt % active to about 60 wt % active of a third solvent; from about 5 wt % active to about 15 wt % active of a fourth solvent that is different than the third solvent; from about 0.00445 wt % active to about 0.89 wt % active of another single photobleachable dye selected from the group consisting of Acid Red 52 and Acid Blue 9; and a balance of water.

In the second fusing agent, the third solvent may be any of the examples of the first solvent, and the fourth solvent may be any of the examples of the second solvent. Additionally, the additive(s) set forth herein for the fusing agent may be used in the respective amounts set forth herein for the fusing agent.

In examples that utilize the first and second fusing agents, it is to be understood that the single photobleachable dye in the first fusing agent is less photobleachable than the single photobleachable dye in the second fusing agent, and may be selected to impart the predetermined color (because the second photobleachable dye bleaches to white or off-white) or to mix with the photobleached color to achieve the predetermined color (because the second photobleachable dye bleaches to a light color). Alternatively, the first and second fusing agents may be used to obtain multi-toned parts, where the colors are respectively determined by the photobleaching of the two photobleachable dyes used alone or in combination. For example, a first fusing agent containing Acid Yellow 73 and a second fusing agent containing Acid Red 52 and Acid Yellow 73 may be used to generate 3D printed and photobleached parts with light yellow or colorless sections (initially patterned with the first fusing agent), yellow sections (initially patterned with second fusing agent), and yellow or slightly darker yellow sections (initially patterned with the first and second fusing agents).

### Detailing Agent

The detailing agent may include a surfactant, a co-solvent, and a balance of water. In an example, the detailing agent consists of these components and no other components. In another example, the detailing agent further includes additional components, such as anti-kogation agent(s), antimicrobial agent(s), and/or chelating agent(s), each of which is described above in reference to the fusing agent. The balance of the detailing agent is water. As such, the amount of water may vary depending upon the amounts of the other components that are included in the detailing agent.

Suitable surfactant(s) for the detailing agent include non-ionic or anionic surfactants. It may be suitable to select a surfactant that does not react with the aromatic alcohol if used in the color assist agent. Some example surfactants include alkyl polyethylene oxides, alkyl phenyl polyethylene oxides, polyethylene oxide block copolymers, acetylenic polyethylene oxides, polyethylene oxide (di)esters, polyethylene oxide amines, dimethicone copolyols, substituted amine oxides, fluorosurfactants, and the like. Some specific examples include a self-emulsifiable, non-ionic wetting agent based on acetylenic diol chemistry (e.g., SURFYNOL® SEF from Evonik Degussa), a non-ionic fluorosurfactant (e.g., CAPSTONE® fluorosurfactants, such as CAPSTONE® FS-35, from Chemours), an ethoxylated low-foam wetting agent (e.g., SURFYNOL® 440 or SURFYNOL® CT-111 from Evonik Degussa), an ethoxylated wetting agent and molecular defoamer (e.g., SURFYNOL® 420 from Evonik Degussa), non-ionic wetting agents and molecular defoamers (e.g., SURFYNOL® 104E from Evonik Degussa), and/or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TEGO® Wet 510 (organic surfactant) available from Evonik Degussa). Yet another suitable (anionic) surfactant includes alkyldiphenyloxide disulfonate (e.g., the DOWFAX™ series, such a 2A1, 3B2, 8390, C6L, C10L, and 30599, from The Dow Chemical Company).

Whether a single surfactant is used, or a combination of surfactants is used, the total amount of surfactant(s) ranges from about 0.01 wt % active to about 2 wt % active, based on the total weight of the detailing agent. In another example, the total amount of surfactant(s) ranges from about 0.5 wt % active to about 1.5 wt % active, based on the total weight of the detailing agent. In a particular example, the total amount of surfactant(s) used is about 0.85 wt % active, based on the total weight of the detailing agent.

The detailing agent may also include co-solvent(s). Classes of water-soluble or water-miscible organic co-solvents that may be used in the detailing agent include aliphatic alcohols, aromatic alcohols, diols, glycol ethers, polyglycol ethers, lactams, formamides (substituted and unsubstituted), acetamides (substituted and unsubstituted), glycols, and long chain alcohols. Examples of these co-solvents include primary aliphatic alcohols, secondary aliphatic alcohols, 1,2-alcohols, 1,3-alcohols, 1,5-alcohols, other diols (e.g., 2-methyl-1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, 1-methyl-2-pyrrolidone, 2-pyrrolidone, and the like. Other examples of suitable organic co-solvents include dimethyl sulfoxide (DMSO), isopropyl alcohol, ethanol, pentanol, acetone, or the like.

Whether a single co-solvent is used, or a combination of co-solvents is used, the total amount of co-solvent(s) ranges from about 1 wt % active to about 10 wt % active, based on the total weight of the detailing agent. In a particular example, the total amount of co-solvent(s) used is about 4 wt % active, based on the total weight of the detailing agent.

The examples of the detailing agent disclosed herein do not include a colorant. As such, the detailing agent is colorless. As used herein, “colorless” means that the detailing agent is achromatic and does not include a colorant. The colorless detailing agent, in combination with the fusing agent, may be used to generate 3D object layer(s)/object(s) exhibiting a base color and that is photobleachable.

### Polymeric Build Material Composition

The fusing agent of the present disclosure may be suitable for printing on a polymeric build material composition (referred to interchangeably herein as the “build material composition” or simply “build material”). Some examples of suitable polymeric materials for the polymeric build material composition include polyamides, polyacetals, polyolefins, styrene polymers and copolymers (e.g., polystyrene), fluoropolymers, acrylic polymers and copolymers, polyethers, polyaryletherketones, polyesters (e.g., a thermoplastic copolyester (TPC)), polycarbonates (PC), a thermoplastic polyurethane elastomer (TPU), a thermoplastic polyolefin elastomer (TPO), a thermoplastic vulcanizate (TPV), a polyether block amide (PEBA), or a combination thereof. In an example, the polymer material is selected from the group consisting of polyethylene, polyethylene terephthalate (PET), polystyrene (PS), polypropylene, high density polyethylene (HDPE), polyoxymethylene (POM), polyether ketone (PEK), polyether ether ketone (PEEK), polyetherketoneketone (PEKK), polyphenylene sulfide (PPS), polytetrafluoroethylene (PTFE), polyvinylidene fluoride (PVDF), acrylonitrile styrene acrylate (ASA), poly(methyl methacrylate) (PMMA), styrene acrylonitrile (SAN), styrene maleic anhydride (SMA), poly(vinyl chloride) (PVC), polyethylenimine (PEI), and combinations thereof. In some instances, the polymeric material may be referred to herein as an elastomer.

In some examples, the polymeric build material composition includes thermoplastic polyamide. For instance, the polymeric build material composition is a polyamide build material composition including polyamide particles. Examples of suitable polyamides include polyamide-11 (PA 11/nylon 11), polyamide-12 (PA 12/nylon 12), polyamide-6 (PA 6/nylon 6), polyamide-8 (PA 8/nylon 8), polyamide-9 (PA 9/nylon 9), polyamide-66 (PA 66/nylon 66), polyamide-612 (PA 612/nylon 612), polyamide-812 (PA 812/nylon 812), polyamide-912 (PA 912/nylon 912), etc.), a thermoplastic polyamide (TPA), and combinations thereof.

The polymeric material may be made up of similarly sized particles and/or differently sized particles. In an example, the average particle size of the polymeric material ranges from about 2 μm to about 225 μm. In another example, the average particle size of the polymeric material ranges from about 10 μm to about 130 μm. The term “average particle size,” as used herein, refers to a volume-weighted mean diameter of a particle distribution.

In some examples, in addition to the polymeric material, the build material composition may include an antioxidant, an antistatic agent, a flow aid, or a combination thereof. In an example, the build material composition is free of a whitener. Photobleachable parts can be formed by 3D printing using the examples of the fusing agent disclosed herein, and these parts can be photobleached to form white and off-white parts even in the absence of a whitener from the build material composition. However, it is to be understood that the fusing agent may also be used with a build material composition that does contain a whitener. The presence of the whitener may increase the L* and/or the brightness of the post-processed 3D printed part.

While several examples of the build material composition additives are provided, it is to be understood that these additives are selected to be thermally stable (i.e., will not decompose) at the 3D printing temperatures.

Antioxidant(s) may be added to the build material composition to prevent or slow molecular weight decreases of the polymeric material and/or to prevent or slow discoloration (e.g., yellowing) by preventing or slowing oxidation of the polymeric material. In some examples, the polymeric material may discolor upon reacting with oxygen, and this discoloration may contribute to the discoloration of the build material composition. The antioxidant may be selected to minimize discoloration. In some examples, the antioxidant may be a radical scavenger. In these examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4-hydroxy-5-methylphenyl), polyvinyl alcohol and deionized water), and/or other sterically hindered phenols. In other examples, the antioxidant may include a phosphite and/or an organic sulfide (e.g., a thioester). The antioxidant may be in the form of fine particles (e.g., having an average particle size of 5 μm or less) that are dry blended with the polymeric material.

In an example, the antioxidant may be included in the build material composition in an amount ranging from about 0.01 wt % to about 5 wt %, based on the total weight of the build material composition. In other examples, the antioxidant may be included in the build material composition in an amount ranging from about 0.01 wt % to about 2 wt % or from about 0.2 wt % to about 1 wt %, based on the total weight of the build material composition.

Whitener(s) may be added to the build material composition in certain examples to bring the L* of the build material composition closer to 100 (white). It is to be understood, however, that some examples of the build material composition do not include the whitener. Examples of suitable whiteners include titanium dioxide (TiO₂), zinc oxide (ZnO), calcium carbonate (CaCO₃), zirconium dioxide (ZrO₂), aluminum oxide (Al₂O₃), silicon dioxide (SiO₂), boron nitride (BN), barium sulfate, and combinations thereof. In some examples, a stilbene derivative may be used as the whitener and a brightener. In these examples, the temperature(s) of the 3D printing process may be selected so that the stilbene derivative remains stable (i.e., the 3D printing temperature does not thermally decompose the stilbene derivative).

When included, any example of the whitener may be included in the build material composition in an amount ranging from greater than 0 wt % to about 10 wt %, based on the total weight of the build material composition.

Antistatic agent(s) may be added to the polymeric build material composition to suppress tribo-charging. Examples of suitable antistatic agents include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available antistatic agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.).

In an example, the antistatic agent is added in an amount ranging from greater than 0 wt % to less than 5 wt %, based on the total weight of the build material composition.

Flow aid(s) may be added to improve the coating flowability of the polymeric build material composition. Flow aids may be particularly beneficial when the polymeric material in the build material composition has an average particle size less than 25 μm. The flow aid improves the flowability of the build material composition by reducing the friction, the lateral drag, and the tribocharge buildup (by increasing the particle conductivity). Examples of suitable flow aids include aluminum oxide (Al2O₃), tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), and polydimethylsiloxane (E900).

In an example, the flow aid is added in an amount ranging from greater than 0 wt % to less than 5 wt %, based on the total weight of the build material composition.

### 3D Printing Methods

Examples of 3D printing methods utilizing the fusing agent and utilizing two fusing agents are described in detail below. Prior to execution of either of the methods, it is to be understood that a controller may access data stored in a data store pertaining to a 3D solid part (or 3D printed object) that is to be made/printed. For example, the controller may determine the number of layers of a build material composition that are to be formed, the locations at which the fusing agent(s) (and detailing agent, if used) is/are to be deposited on each of the respective layers, etc.

One example method includes applying the polymeric build material composition to form a build material layer, based on a 3D object model, selectively applying a fusing agent onto at least a portion of the build material layer, thereby forming a patterned portion. The fusing agent used in the method may be any of the example formulations described above (e.g., including the single photobleachable dye or the combination of photobleachable dyes). In another example, the method further includes, based on the 3D object model, applying the detailing agent onto another portion of the build material layer.

In an example method, a layer of the build material composition is applied to form a build material layer on a build area platform. It is to be understood that any of the polymeric materials described herein may be used in the method as the build material composition. A printing system may be used to apply the build material composition. The printing system may include the build area platform, a build material supply containing the build material composition, and a build material distributor.

The build area platform receives the build material composition from the build material supply. The build area platform may be moved in various directions so that the build material composition may be delivered to the build area platform or to a previously formed layer. In an example, when the build material composition is to be delivered, the build area platform may be programmed to advance (e.g., downward or in the Z direction relative to the X-Y plane of the build area platform) enough so that the build material distributor can push the build material composition onto the build area platform to form a substantially uniform layer of the build material composition thereon. The build area platform may also be returned to its original position, for example, when a new part is to be built.

The build material supply may be a container, bed, or other surface that is to position the build material composition between the build material distributor and the build area platform. The build material supply may include heaters so that the build material composition is heated to a supply temperature ranging from about 25° C. to about 200° C. In these examples, the supply temperature may depend, in part, on the build material composition used and/or the 3D printer used. As such, the range provided is one example, and higher or lower temperatures may be used.

The build material distributor may be moved in various directions, over the build material supply, and across the build area platform to spread the layer of the build material composition over the build area platform. The build material distributor may also be returned to a position adjacent to the build material supply following the spreading of the build material composition. The build material distributor may be a blade (e.g., a doctor blade), a roller, a combination of a roller and a blade, and/or any other device capable of spreading the build material composition over the build area platform. For instance, the build material distributor may be a counter-rotating roller. In some examples, the build material supply or a portion of the build material supply may translate along with the build material distributor such that build material composition is delivered continuously to the build area platform.

The build material supply may supply the build material composition into a position so that the build material composition is ready to be spread onto the build area platform. The build material distributor may spread the supplied build material composition onto the build area platform. The controller may process “control build material supply” data, and in response, control the build material supply to appropriately position the particles of the build material composition, and may process “control spreader” data, and in response, control the build material distributor to spread the build material composition over the build area platform to form the layer.

The build material layer has a substantially uniform thickness across the build area platform. In an example, the build material layer has a thickness ranging from about 50 μm to about 120 μm. In another example, the thickness of the build material layer ranges from about 30 μm to about 300 μm. It is to be understood that thinner or thicker layers may also be used. For example, the thickness of the build material layer may range from about 20 μm to about 500 μm. The layer thickness may be about 2× (i.e., 2 times) the average diameter of the polymeric material at a minimum for finer part definition. In some examples, the layer thickness may be about 1.2× the average diameter of the polymeric material in the build material composition.

After the build material composition has been applied, and prior to further processing, the build material layer may be exposed to heating. In an example, the heating temperature may be below the melting point or melting range of the polymeric material in the build material composition. As examples, the pre-heating temperature may range from about 5° C. to about 50° C. below the melting point or the lowest temperature of the melting range of the polymeric material. In an example, the pre-heating temperature ranges from about 50° C. to about 205° C. In still another example, the pre-heating temperature ranges from about 100° C. to about 190° C. It is to be understood that the pre-heating temperature may depend, in part, on the build material composition used. As such, the ranges provided are some examples, and higher or lower temperatures may be used.

Pre-heating the layer may be accomplished by using any suitable heat source that exposes all of the build material composition in the build material layer to the heat. Examples of the heat source include a thermal heat source (e.g., a heater integrated into the build area platform (which may include sidewalls)) or a radiation source. After the layer is formed, and in some instances is pre-heated, the fusing agent is selectively applied on at least some of the build material composition in the layer to form a patterned portion.

The amount of the fusing agent that is applied per unit of the build material composition in the patterned portion may be sufficient to absorb and convert enough energy so that the build material composition in the patterned portion will coalesce. The amount of the fusing agent that is applied per unit of the build material composition may depend, at least in part, on the loading of the photobleachable dye(s) in the fusing agent and the polymeric material in the build material composition. In particular, the concentration of the dye(s) in the fusing agent can be considered. This concentration can be used to determine how much fusing agent to apply to achieve a weight ratio of fusing agent to build material composition for acceptable layer-by-layer fusing. If applying the fusing agent to the build material composition at about a 1:9 weight ratio, then the dye to build material composition weight ratio (as applied) can be from about 4.45:900,000 to about 89:90,000. If more or less of the fusing agent is applied to the build material composition, then these ratios can be adjusted accordingly.

The fusing agent further includes a first applicator coupled to a first supply, which contains the fusing agent. The fusing agent may be dispensed from the first applicator during printing. The first applicator may include a thermal inkjet printhead, a piezoelectric printhead, a continuous inkjet printhead, etc. in fluid communication with a fluid reservoir/container, and the selective application of the fusing agent may be accomplished by thermal inkjet printing, piezo electric inkjet printing, continuous inkjet printing, etc. The controller may process data, and in response, control the applicator to deposit the fusing agent onto pre-determined portion(s) of the build material composition to generate the patterned portion.

In some examples, the method further comprises selectively applying, based on the 3D object model, the detailing agent onto another portion of the build material layer outside of the patterned portion. The detailing agent may be selectively applied to the portion(s) of the layer that are not patterned with the fusing agent, and thus that are not to become part of a final 3D object layer. Thermal energy generated during radiation exposure may propagate into the surrounding portion(s) that do not have the fusing agent applied thereto. The propagation of thermal energy may be inhibited and, in turn, the coalescence of the non-patterned build material portion(s) may be prevented when the detailing agent is applied to these other portion(s).

In some other examples, the detailing agent may also or alternatively be applied to the patterned portion or a portion of the patterned portion (i.e., with the fusing agent). The detailing agent may be applied to the patterned portion to provide a cooling effect so that the build material does not overheat and/or to lower the extent of fusing in the area patterned with both the fusing agent and the detailing agent. In these examples, the amount of the detailing agent that is applied should be low enough so that fusing is not completely inhibited. In other examples, the detailing agent and the fusing agent may intermingle at the edge(s) between the patterned portion and the other portion(s).

The detailing agent may be dispensed from a second applicator. The second applicator may include a thermal inkjet printhead, a piezoelectric printhead, a continuous inkjet printhead, etc. in fluid communication with a third supply (which may be a fluid reservoir/container) containing the detailing agent. The selective application of the detailing agent may be accomplished by thermal inkjet printing, piezo electric inkjet printing, continuous inkjet printing, etc. The controller may process data, and in response, control the applicator to deposit the detailing agent onto predetermined portion(s) of the build material composition to generate the portion(s).

It is to be understood that the selective application of any of the fusing agent and/or the detailing agent may be accomplished in a single printing pass or in multiple printing passes. In some examples, the agent(s) is/are selectively applied in a single printing pass. In some other examples, the agent(s) is/are selectively applied in multiple printing passes. In one of these examples, the number of printing passes ranges from 2 to 4. The fusing agent and/or the detailing agent may be applied in multiple printing passes to increase the amount, which is applied to the build material composition, to avoid liquid splashing, to avoid displacement of the build material composition, etc.

After the fusing agent and/or detailing agent are selectively applied in the specific portion(s) of the layer, the entire layer of the build material composition is exposed to electromagnetic radiation in the form of visible light. The electromagnetic radiation is emitted from a visible light source. The radiation source may include visible light lamps, visible light emitting diodes (LEDs), or another broad-spectrum light source emitting the suitable visible light wavelength(s). The length of time the electromagnetic radiation is applied for, or energy exposure time, may be dependent, for example, on characteristics of the radiation source, characteristics of the build material composition, and/or characteristics of the fusing agent. In an example, a single point of the build material layer is exposed to electromagnetic radiation for a period of time ranging from 0.01 second to 1 second.

It is to be understood that the electromagnetic radiation exposure may be accomplished in a single radiation event or in multiple radiation events. The term “event,” as used herein, refers to one period of exposure of electromagnetic radiation from the radiation source. In an example, a radiation event may occur as a pass of a moveable radiation source over the build material layer (similar to a printing pass). In an example, the exposing of the build material composition is accomplished in multiple radiation events. In a specific example, the number of radiation events ranges from 1 to 8. In still another specific example, the exposure of the build material composition to electromagnetic radiation may be accomplished in 3 radiation events. The build material composition may be exposed to electromagnetic radiation in multiple radiation events to counteract a cooling effect that may be brought on by the amount of the 3D printing fusing agent, alone or in combination with the detailing agent that is applied to the build material layer. Additionally, the build material composition may be exposed to electromagnetic radiation in multiple radiation events to sufficiently elevate the temperature of the build material composition in the portion(s) without overheating the build material composition in the non-patterned portion(s).

The fusing agent enhances the absorption of the electromagnetic radiation, converts the absorbed radiation to thermal energy, and promotes the transfer of the thermal energy (heat) to the build material composition in contact therewith. In an example, the fusing agent sufficiently elevates the temperature of the build material composition in the portion to a temperature above the melting point or within the melting range of the polymeric material, allowing coalescing/fusing (e.g., thermal merging, melting, binding, etc.) of the build material composition to take place. The application of the electromagnetic radiation forms the 3D object layer.

In some examples, the electromagnetic radiation has a wavelength ranging from 380 nm to 700 nm. This wavelength range is or falls within the spectrum of visible light. Radiation having wavelengths within the provided ranges may be substantially absorbed (e.g., 80% or more of the applied radiation is absorbed) by the fusing agent and may heat the build material composition in contact therewith. Further, the radiation may not be substantially absorbed (e.g., 25% or less of the applied radiation is absorbed) by the non-patterned build material composition in portion(s).

After the 3D object layer is formed, additional layer(s) may be formed thereon to create an example of the 3D object. To form the next layer, additional build material composition may be applied on the 3D object layer. The fusing agent is then selectively applied on at least a portion of the additional build material composition, according to the 3D object model. The detailing agent may be applied in any area of the additional build material composition where coalescence is not to take place. After the fusing agent and/or detailing agent is/are applied, the entire additional layer of the additional build material composition is exposed to electromagnetic radiation in the manner described herein. The application of additional build material composition, the selective application of the fusing agent, alone or in combination with the detailing agent, and the electromagnetic radiation exposure may be repeated for a predetermined number of cycles to form the final 3D object in accordance with the 3D object model. As such, some examples of the method include repeating the applying of the build material composition, the selectively applying of the fusing agent, and the exposing, to form a predetermined number of 3D object layers and a 3D printed object.

In the examples disclosed herein, a 3D object may be printed in any orientation. For example, the 3D object can be printed from bottom to top, top to bottom, on its side, at an angle, or any other orientation. The orientation of the 3D object can also be formed in any orientation relative to the layering of the build material composition. For example, the 3D object can be formed in an inverted orientation or on its side relative to the layering of the build material composition. The orientation of the build within each layer can be selected in advance or even by the user at the time of printing, for example.

Examples of the method described herein may be used to generate individual 3D object layers that make up a three-dimensional (3D) printed part. Even though the 3D printed article contains the dye(s), the amount of the dye(s) used leads to a 3D printed article exhibiting a base color (i.e., the color has an L*a*b* color consistent with color of the dye(s) used). By “exhibits a color,” it is meant that the color of 3D printed object being referred to closely resembles the color of the dye or combination of dye(s) included in the fusing agent.

As mentioned, another example method utilizes the first and second fusing agents described herein (each of which includes a single photobleachable dye as described). This example method includes applying the polymeric build material composition to form a build material layer; based on a 3D object model, selectively applying a first fusing agent onto a first portion of the build material layer, thereby forming a first patterned portion; based on the 3D object model, selectively applying a second fusing agent onto the first patterned portion, and/or onto a second portion of the build material layer, thereby forming a second patterned portion; and exposing the first patterned portion or the first and second patterned portions to electromagnetic radiation in the form of visible light, thereby coalescing the first patterned portion or the first and second patterned portions. Each of these processes can be performed as described herein. These processes can be repeated to build the 3D printed object. The post-processing photobleaching can be performed as described herein.

In this example method, the first and second fusing agents can be used in separate portions or in the same portions, depending upon the predetermined color of the final photo-bleached part.

The detailing agent can also be used in the method that uses two fusing agents in accordance with the description set forth herein.

### 3D Printed Object

The 3D printed object formed by the 3D printing method described above is a colored object and may be referred to as a “colored 3D printed object” or a 3D printed object having a base color. The base color of the 3D printed object is the color of the 3D printed object prior to post-process photobleaching and may be referred to as the original or initial color of the 3D printed object. When the first and second fusing agents are used, the 3D printed object may exhibit two or three base colors, depending upon whether the agents are printed together and/or separately.

The colored 3D printed object includes coalesced polymeric material and exhibits a base color or multiple base colors in different sections due, at least in part, to the photobleachable dye(s) used in the fusing agent(s) during printing. As such, at least some of the photobleachable dye(s) of the fusing agent(s) remain in the object. As will be illustrated in the Examples section, it has been found that the base color(s) of the 3D printed object can be readily photobleached to a white, off-white, or light color that can be selected from a wide selection of colors.

The 3D printed object includes a plurality of build material layers of coalesced polymeric build material. While most of the solvent(s) is/are evaporated during printing, a residual amount of the solvent(s) is likely to remain. In an example, less than 3 wt % of the solvent(s) remains in the 3D printed object.

It is to be understood that other components of the build material composition (e.g., flow aid, etc.) and components of the fusing agent that do not evaporate may also be present in the 3D printed object. The weight percentage of each component may depend on the amount used in the build material composition and/or the fusing agent, the dimensions of the 3D printed object, the amount of the fusing agent applied, the evaporation rate (if any) of the components, and other like conditions or parameters.

### Post-Process Photobleaching

Once the 3D printed object is formed, the 3D printed object is exposed to a predetermined wavelength of light for a predetermined amount of time, thereby altering an initial or base color or colors of the 3D printed object. Light for photobleaching may have a wavelength falling within the visible light spectrum, the UV light spectrum, the IR light spectrum, and/or other wavelengths. In an example, the 3D printed object is exposed to UV radiation, e.g., sunlight. The UV radiation source may be natural/direct sunlight or light generated from a sunlamp. All of the photobleachable dyes disclosed herein can be photobleached using sunlight or other UV light. Other light sources include Xenon arc lamps and fluorescent lights. Exposure conditions may also include elevated temperatures and certain relative humidity. When a chamber is used for post-print photobleaching, the chamber size may be adjusted to achieve certain conditions.

The 3D object may be exposed to the light for an amount of time sufficient to accomplish a particular level of photobleaching. In an example, the 3D object is exposed to the light for 6 hours, 12 hours, 24 hours, or any other time period sufficient to achieve the predetermined level of photobleaching. The 3D object may be photobleached, for example, by exposing the 3D object to natural sunlight or to light generated from a sunlamp for a period of 3 to 4 weeks.

To further illustrate the present disclosure, example(s) are given herein. It is to be understood that these example(s) are provided for illustrative purposes and are not to be construed as limiting the scope of the present disclosure.

### EXAMPLES

### Fusing Agent Including a Single Photobleachable Dye

Four sample fusing agents (F1-F4) were prepared for use in some of the examples below, each including a low loading of a single photobleachable dye. The fusing agents F1 and F2 included Acid Yellow 23 (AY-23) as the photobleachable dye, and the fusing agents F3 and F4 included Acid Yellow 73 (AY-73) as the photobleachable dye. The formulations of the fusing agent samples F1-F4 are set forth in Table 2 below:

TABLE 2

| | | F1 | F2 | F3 | F4 |
|---|---|---|---|---|---|
| Component | % active | (wt %) | (wt %) | (wt %) | (wt %) |
| HE2P | 100 | 20-60 | 20-60 | 20-60 | 20-60 |
| AY-23 | 8.9 | 0.5 | 0.75 | 0 | 0 |
| AY-73 | 8.9 | 0 | 0 | 0.3 | 0.4 |
| Benzyl Alcohol | 100 | 5-15 | 5-15 | 5-15 | 5-15 |
| TERGITOL ® 15-S-9 | 100 | 0.75 | 0.75 | 0.75 | 0.75 |
| Water | 100 | Balance | Balance | Balance | Balance |

### Two-Dimensional Printing Tests

Each of the sample fusing agents F1-F4 was printed on plain paper using a two-dimensional (2D) inkjet printer. In particular, a missing nozzles test was performed for each of the fusing agents. A test print was printed to make sure all of the nozzles of the printer were firing properly, which was followed by a diagnostic pattern showing the health of each nozzle. For the test print, there was no idle (unfired) time, and thus this print was time=0 seconds. After the test print, the nozzles remained unfired for a predetermined time (i.e., 1 second, 10 seconds, 20 seconds, 40 seconds, 60 seconds, or 80 seconds), and then the diagnostic pattern was printed again. The percentage of missing nozzles was determined for each of the idle (unfired) times relative to the test print, and the results are shown in FIG. 2.

The results in FIG. 2 show that less than 10 percent of the nozzles were missing for each of fusing agents F1, F2, and F4 after all of the idle times. The number of nozzles missing after 1 pass for fusing agent F3 was slightly higher than the threshold of 10 nozzles, otherwise the number of missing nozzles when printing fusing agent F3 fell well below the threshold. These results indicated that each of the fusing agents F1-F4 exhibited good print reliability, in terms of nozzle health.

Each of the fusing agents F1-F4 was tested for decap performance. The term “decap performance,” as referred to herein, means the ability of the fusing agent to readily eject from the printhead upon prolonged exposure to air. The decap time is measured as the amount of time that the printhead may be left uncapped (i.e., exposed to air) before the printer nozzles no longer fire properly, potentially because of clogging, plugging, or retraction of the photobleachable dye from the drop forming region of the nozzle/firing chamber. Thus, the decap score is measured as line quality relative to reference line. To test decap performance, a reference line of the ink was printed from a printhead that was not uncapped (i.e., was not exposed to air, i.e., unfired time=0 seconds). Then, the printhead was filled with the fusing agent and left uncapped (i.e., exposed to air) for 12 seconds before the fusing agent was ejected again from the printhead.

The results of the decap test is shown in FIG. 3, which is a graph of an overall decap score vs. the decap time (seconds). A lower decap score indicated a better decap performance. The results in FIG. 3 indicated that after 12 seconds, all of the fusing agents F1-F4 exhibited good decap performance.

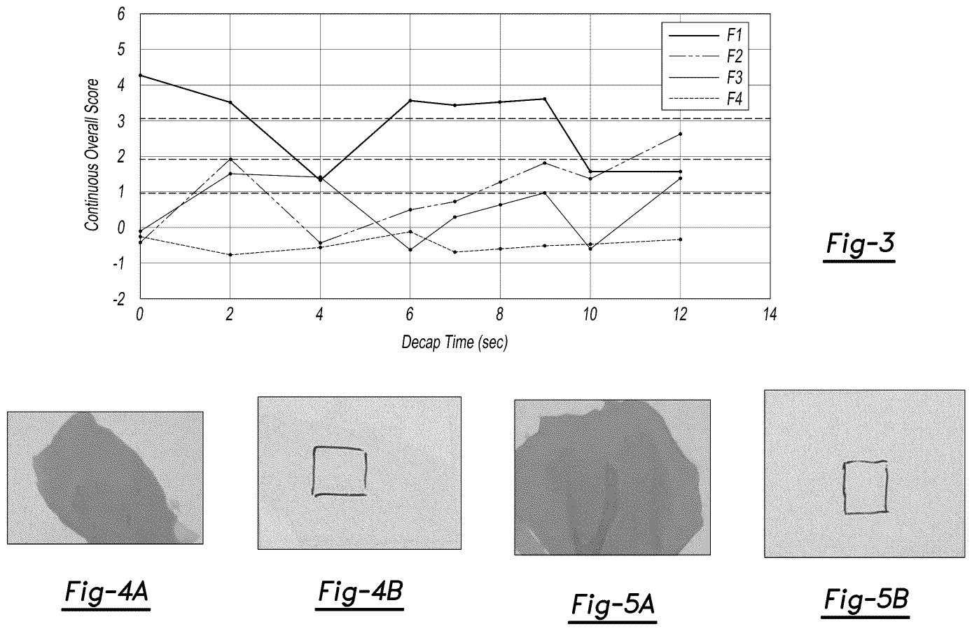

The fusing agent F1 (which included 0.5 wt % of AY-23 dye) was applied with a paint brush to plain paper to produce Test Print 1. The fusing agent F3 (which included 0.3 wt % of AY-73 dye) was also applied with a paint brush to plain paper to produce Test Print 2. A photograph of Test Prints 1 and 2 are shown in FIGS. 4A and 5A, respectively. Each of the Test Prints 1 and 2 showed a print region having a medium yellow color.

Each of the Test Prints 1 and 2 was exposed to UV radiation (Q-Sun Xenon test chamber, model XE-3HC) for 24 hours and then evaluated for photobleaching. Photographs of the Test Prints 1 and 2 after UV radiation exposure are shown in FIGS. 4B and 5B, respectively. Test Print 1 (which was formed using fusing agent 1 including AY-23 dye), shown in FIG. 4B, experienced fading of the bold yellow color, indicating that the fusing agent F1, including the AY-23 dye, underwent photobleaching. Test Print 2 (which was formed using fusing agent F3 including the AY-73 dye), shown in FIG. 5B, experienced significant fading such that the fusing agent F3 appeared colorless. These results indicate that the fusing agent F3, including the AY-73 dye, underwent photobleaching to a greater extent than fusing agent F1.

Each of the fusing agents F1-F4 was applied to plain paper to form Test Prints 5-8, respectively, and the optical density of the initial Test Prints 5-8 (i.e., at T₀) was measured. All of the Test Prints 5-8 at T₀ exhibited a medium yellow color at the print region. Each of the Test Prints 5-8 was then exposed to sunlight for 24 hours and the optical density of the final Test Prints 5-8 (i.e., at T_{24 hr}) was measured. The “optical density,” as used herein, is a measure of the amount of light absorbed by the print, indicating how dark or opaque it is. The higher the optical density (OD), the more light the ink absorbs and the darker the print will appear. The results are shown in Table 3 below:

TABLE 3

| Sample | OD (T₀) | OD (T_{24 hr}) | ΔOD | % OD loss |
|---|---|---|---|---|
| Test Print 5 | 0.9213 | 0.3430 | −0.5783 | 62.77% |
| Test Print 6 | 1.0862 | 0.4178 | −0.6684 | 61.54% |
| Test Print 7 | 0.8875 | 0.0691 | −0.8184 | 92.21% |
| Test Print 8 | 1.0407 | 0.0567 | −0.984 | 94.55% |

The results in Table 3 above show a significant change in optical density for each of the Test Prints 5-8 after exposure to sunlight. The Test Prints 5 and 6, which were generated using a low loading of the AY-23 dye, exhibited a 62.77% OD loss and a 61.54% OD loss, respectively. This means that the initial medium yellow color of the Test Prints 5 and 6 faded to a light-yellow color. Test Prints 7 and 8, which were generated using a low loading of AY-73 dye, exhibited a 92.21% OD loss and a 94.55% OD loss, respectively. This means that the initial medium color of Test Prints 7 and 8 faded almost completely and, thus, the printed region appears colorless. These results are consistent with FIGS. 4 and 5.

### Melt-Fused Coupons Tests

Fusing agents F3 and F4, both including a low loading of AY-73 dye, were applied to polyamide-12 powder and then heated to form melt-fused coupons 1 and 2, respectively. The optical density of the initial coupons 1 and (i.e., at T₀) was measured. Both of the coupons 1 and 2 were then exposed to sunlight for 24 hours and the optical density of the final coupons 1 and 2 (i.e., at T_{24 hr}) was measured. The results are shown in Table 4 below:

TABLE 4

| Sample | OD (T₀) | OD (T_{24 hr}) | ΔOD | % OD loss |
|---|---|---|---|---|
| Coupon 1 | 0.6615 | 0.4413 | −0.22 | 33.29% |
| Coupon 2 | 0.6758 | 0.5258 | −0.15 | 22.20% |

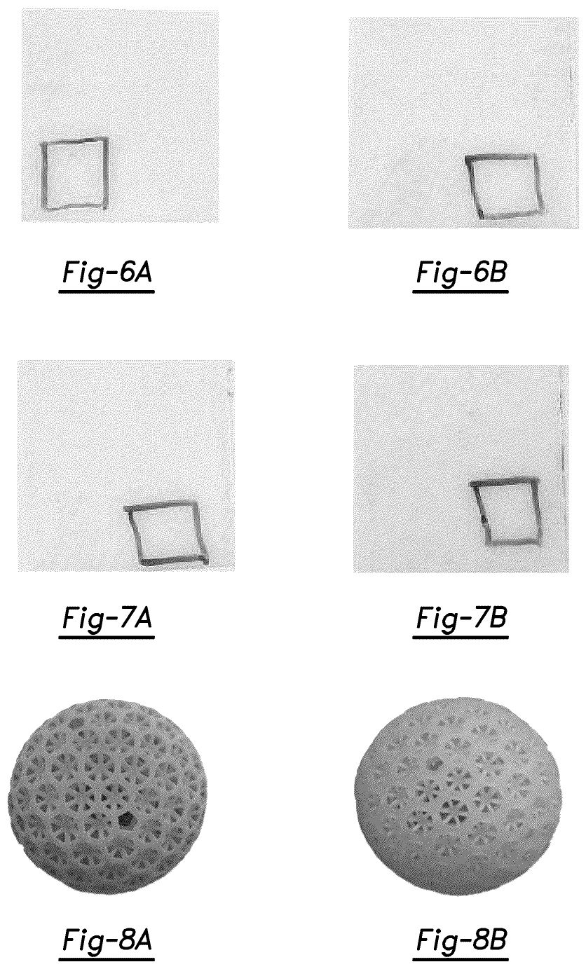

The results in Table 4 above show a change in optical density for each of the Coupons 1 and 2. Photographs of Coupons 1 and 2 at T₀ are shown in FIGS. 6A and 7A, respectively. Each of the Coupons 1 and 2 at T₀ exhibited a very light-yellow color. After exposure to sunlight for 24 hours, Coupon 1 exhibited a 33.29% OD loss and Coupon 2 exhibited a 22.20% OD loss. Photographs of Coupons 1 and 2 at T_{24 hrs} are shown in FIGS. 6B and 7B, respectively. Each of the Coupons 1 and 2 after exposure to sunlight exhibited an off-white color. These results indicate that 3D objects formed using the fusing agents including the AY-73 dye suitably photobleach to generate almost colorless parts.

### Three-Dimensional Printing Tests

Another sample fusing agent F5 was prepared including a low loading of a combination of Acid Yellow 23 (AY-23) dye and Acid Red 52 (AR-52) dye. The formulation of fusing agent sample F5 is set forth in Table 5 below:

TABLE 5

| Component | % active | Wt % |
|---|---|---|
| HE2P | 100 | 20-60 |
| AY-23 | 8.9 | 0.1-4 |
| AR-52 | 8 | 0.1-1 |
| Benzyl Alcohol | 100 | 5-15 |
| TERGITOL ® 15-S-9 | 100 | 0.75 |
| Water | 100 | Balance |

A sphere was 3D printed, in a layer-by-layer fashion as described herein, using a build material composition including a thermoplastic polyamide elastomer and the fusing agent F5. The sphere that was printed had an orange base/initial color, as shown in FIG. 8A. The sphere was then exposed to natural sunlight for 4 weeks to photobleach the sphere. Because the loading of the AR-52 dye was smaller compared to the AY-23 dye and the AR-52 dye exhibits a higher fluorescent property compared to the AY-23 dye, the AR-52 dye faded more during photobleaching than the AY-23 dye. Thus, some of the AY-23 dye, and its corresponding yellow color remained, yielding a yellow-colored spherical object, as shown in FIG. 8B. This example illustrates that using of a combination of dyes, having different photobleaching rates, can be used to control the color of the final part.

It is to be understood that the ranges provided herein include the stated range and any value or sub-range within the stated range. For example, from about 0.00445 wt % active to about 0.89 wt % active should be interpreted to include not only the explicitly recited limits of from about 0.00445 wt % active to about 0.89 wt % active, but also to include individual values, such as about 0.006 wt % active, about 0.2 wt % active, about 0.4 wt % active, about 0.8 wt % active, etc., and sub-ranges, such as from about 0.1 wt % active to about 0.7 wt % active, from about 0.02 wt % active to about 0.06 wt % active, from about 0.03 wt % active to about 0.5 wt % active, etc.

Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A fusing agent, comprising:
from about 20 wt % active to about 60 wt % active of a first solvent;
from about 5 wt % active to about 15 wt % active of a second solvent that is different than the first solvent;
from about 0.00445 wt % active to about 5 wt % active of a single photobleachable dye selected from the group consisting of Acid Yellow 73, pyranine, tetrabenzo tetraazoporphyrine, and Acid Blue 9 or a mixture of two photobleachable dyes; and
a balance of water.

2. The fusing agent as defined in claim 1, wherein the fusing agent includes the mixture of two photobleachable dyes, and the mixture of two photobleachable dyes includes:
from about 0.00445 wt % active to about 0.445 wt % active of first photobleachable dye; and
from about 0.00445 wt % active to about 0.445 wt % active of second photobleachable dye that is more fluorescent than the first photobleachable dye.

3. The fusing agent as defined in claim 2, wherein:
the first photobleachable dye is selected from the group consisting of Acid Yellow 23, Acid Yellow 73, and pyranine; and
the second photobleachable dye is selected from the group consisting of Acid Red 52 and Acid Blue 9.

4. The fusing agent as defined in claim 1, wherein:
the first solvent is 1-(2-hydroxyethyl-2-pyrrolidone); and
the second solvent is selected from the group consisting of benzyl alcohol and propylene glycol.

5. The fusing agent as defined in claim 1, further comprising a surfactant.

6. A method for using the fusing agent of claim 1, comprising:
forming a layer of a polymeric build material composition;
based on a 3D object model, selectively applying the fusing agent to the polymeric build material composition; and
exposing the layer to light that the single photobleachable dye or the mixture of two photobleachable dyes is capable of absorbing.

7. The method as defined in claim 6, further comprising:
repeating the forming, the selectively applying, and the exposing to form a 3D object in accordance with the 3D object model; and
exposing the 3D object to a predetermined wavelength of light for a predetermined amount of time, thereby altering an initial color of the 3D object.

8. A three-dimensional (3D) printing kit, comprising:
a fusing agent, including:
from about 20 wt % active to about 60 wt % active of a first solvent;
from about 5 wt % active to about 15 wt % active of a second solvent that is different than the first solvent;
from about 0.00445 wt % active to about 5 wt % active of a single photobleachable dye selected from the group consisting of Acid Yellow 73, pyranine, tetrabenzo tetraazoporphyrine, and Acid Blue 9 or a mixture of two photobleachable dyes; and
a balance of water; and
a polymeric build material composition.

9. The 3D printing kit as defined in claim 8, wherein the fusing agent includes the mixture of two photobleachable dyes, and the mixture of two photobleachable dyes includes:
from about 0.00445 wt % active to about 0.445 wt % active of first photobleachable dye; and
from about 0.00445 wt % active to about 0.445 wt % active of second photobleachable dye that is more fluorescent than the first photobleachable dye.

10. The 3D printing kit as defined in claim 9, wherein:
the first photobleachable dye is selected from the group consisting of Acid Yellow 23, Acid Yellow 73, and pyranine; and
the second photobleachable dye is selected from the group consisting of Acid Red 52 and Acid Blue 9.

11. The 3D printing kit as defined in claim 10, wherein:
the fusing agent includes the single photobleachable dye;
the single photobleachable dye is Acid Yellow 73 or pyranine; and
the 3D printing kit further comprises a second fusing agent including:
from about 20 wt % active to about 60 wt % active of a third solvent;
from about 5 wt % active to about 15 wt % active of a fourth solvent that is different than the third solvent;
from about 0.00445 wt % active to about 0.89 wt % active of an other single photobleachable dye selected from the group consisting of Acid Red 52 and Acid Blue 9; and
a balance of water.

12. The 3D printing kit as defined in claim 8, wherein the polymeric build material composition includes thermoplastic polyamide.

13. The 3D printing kit as defined in claim 8, further comprising a detailing agent.

14. A method, comprising:
selecting a single photobleachable dye or a mixture of two photobleachable dyes to achieve a predetermined color upon photobleaching; and
mixing the single photobleachable dye or the mixture of two photobleachable dyes in a liquid vehicle including at least 50% solvent, thereby forming a fusing agent for three-dimensional printing.

15. The method as defined in claim 14, wherein the liquid vehicle includes:
from about 20 wt % active to about 60 wt % active of a first solvent;
from about 5 wt % active to about 15 wt % active of a second solvent that is different than the first solvent;
a surfactant; and
a balance of water.
